(19) United States
(12) Patent Application Publication
(10) Pub. No.: US 2025/0327523 A1
(43) Pub. Date: Oct. 23, 2025

(54) DIAPHRAGM VALVE

(71) Applicant: KITZ SCT CORPORATION, Tokyo (JP)

(72) Inventor: Gao CHAOKETU, Gunma (JP)

(21) Appl. No.: 19/174,195

(22) Filed: Apr. 9, 2025

(30) Foreign Application Priority Data
Apr. 17, 2024 (JP) 2024-066480

(51) Int. Cl. F16K 7/16

(52) U.S. Cl. CPC F16K 7/16

(57) ABSTRACT

A diaphragm valve in which, even if a thrust force for sealing a valve seat is suppressed small, aligning capability of a diaphragm piece can be enhanced. The diaphragm valve has a diaphragm piece arranged so as to freely abut on a tip of a stem and causing a valve-close state in which a diaphragm is caused to abut on a valve seat via the diaphragm piece pushed by the stem to a valve-closing direction. The stem has a tip surface forming a spherical shape. The diaphragm piece is provided with a recessed portion where a tip portion of the stem is placed. The recessed portion has an inner bottom surface having a radius of curvature larger than a radius of curvature of the tip surface of the stem and forming a spherical shape with a center portion as a lowermost surface.

### BACKGROUND OF THE INVENTION

### Field of the Invention

The present invention relates to diaphragm valves, and a diaphragm valve that opens and closes valve by a diaphragm by movement of a stem.

### Description of the Related Art

Conventionally, valves for use in semiconductor manufacturing apparatuses, solar battery manufacturing apparatuses, liquid-crystal manufacturing apparatuses, and so forth have a less dead space, and is required to suppress the occurrence of particles. As a valve that addresses this requirement, diaphragm valves are often used.

In the diaphragm valve, the diaphragm and the valve seat wear out by being repeatedly in contact with and separated from each other. Thus, it is required to periodically replace a wear component such as the diaphragm or the valve seat.

In particular, when the valve is used for a process of causing the valve to make open and close operations at high temperatures and high speed, such as, for example, ALD (Atomic Layer Deposition) process, the valve seat and so forth tend to wear out more, and the wear component such as a valve seat has to be frequently replaced.

The diaphragm valve in which its components greatly wear out is particularly required to be made highly durable. To make it highly durable, it is required to decrease a thrust force for sealing the valve seat to suppress damages to the valve seat.

Also, on the other hand, to make component replacement easily performed at the time of maintenance, it is required to improve ease of disassembly and assembly.

For example, Japanese Unexamined Patent Application Publication (Translation of PCT Application) No. 2016-505125 describes a diaphragm valve with improved ease of disassembly and assembly.

In this gazette, the diaphragm valve having an assembly or cartridge that promotes replacement of the diaphragm, the valve seat, or both is suggested.

In the diaphragm valve described in this gazette, at the time of valve closing, the diaphragm is caused to abut on a valve seat via a button (diaphragm piece) arranged at a tip side of an actuator stem.

### BRIEF SUMMARY OF THE INVENTION

However, the diaphragm valve described in this gazette has a problem in which, when a thrust force for sealing the valve seat is small, for example, due to an influence of a gap as a play of the stem and the diaphragm piece in the valve due to erection tolerance allowing ease of disassembly and assembly, the stem may rattle to cause the way of thrusting the diaphragm piece by the stem to become nonuniform, and becomes susceptible to an influence such as the tilt of the valve seat due to nonuniformity in parallelism of the valve seat and the valve body due to erection tolerance to make sealability unstable.

To solve this problem, it is required to stabilize the movement of the diaphragm piece in the axial center direction and also enhance aligning capability of the diaphragm piece.

The present invention was developed to solve the conventional problem, and has an object of providing a diaphragm valve in which, in a structure with erection tolerance allowing ease of disassembly and assembly, even if a thrust force for sealing a valve seat is suppressed small, aligning capability of a diaphragm piece can be enhanced and seal capability of the valve seat can be kept, thereby further allowing an improvement in seal capability of the valve seat.

To achieve the above-described object, a first aspect of the present invention is directed to a diaphragm valve having a diaphragm piece arranged so as to freely abut on a tip of a stem and causing a valve-close state in which a diaphragm is caused to abut on a valve seat via the diaphragm piece pushed by the stem to a valve-closing direction, in which the stem has a tip surface forming a spherical shape, the diaphragm piece is provided with a recessed portion where a tip portion of the stem is placed, and the recessed portion has an inner bottom surface having a radius of curvature larger than a radius of curvature of the tip surface of the stem and forming a spherical shape with a center portion as a lowermost surface.

A second aspect of the present invention is directed to the diaphragm valve, in which the inner bottom surface of the recessed portion is formed at a deeper position as long as a predetermined strength can be ensured.

A third aspect of the present invention is directed to the diaphragm valve further including a retaining member for movably retaining the diaphragm piece to an axial center direction of the diaphragm piece, in which the diaphragm piece has a height in the axial center direction so as to be able to be guided by the retaining member to the axial center direction by taking a side-portion outer circumferential surface of the diaphragm pieces as a sliding surface.

According to the first aspect of the present invention, the stem has a tip surface forming a spherical shape, the diaphragm piece is provided with a recessed portion where a tip portion of the stem is placed, and the recessed portion has an inner bottom surface having a radius of curvature larger than a radius of curvature of the tip surface of the stem and forming a spherical shape with a center portion as a lowermost surface.

With this, when the tip surface of the stem pressurizes the inner bottom surface of the recessed portion of the diaphragm piece for valve closing, the stem causes the spherical tip surface to abut on the spherical inner bottom surface of the recessed portion to be moved toward the lowermost surface of the inner bottom surface.

Thus, the position to be pressurized by the stem the diaphragm piece is closer to the valve seat. When the stem is tilted to pressurize the inner bottom surface of the diaphragm piece separate from the stem, the moment for rotating the diaphragm piece is suppressed small and the diaphragm piece is prevented from being tilted more as the aligning capability is degraded more due to a play of erection tolerance.

Therefore, in the structure with erection tolerance allowing ease of disassembly and assembly, even if a thrust force for sealing the valve seat is suppressed small, aligning capability of the diaphragm piece can be enhanced and seal capability of the valve seat can be kept, thereby further allowing an improvement in seal capability of the valve seat.

According to the second aspect of the present invention, the inner bottom surface of the recessed portion of the diaphragm piece is formed at a deeper position as long as a predetermined strength can be ensured. With this, the tip surface of the stem can pressurize the inner bottom surface at a deeper position in the recessed portion.

Since the stem pressurizes the inner bottom surface at a position closer to the valve seat, the moment acting on the diaphragm piece when the stem is tilted to pressurize the inner bottom surface of the recessed portion can be suppressed small while the strength of the diaphragm piece is ensured.

Furthermore, the tip portion of the stem can be placed to a deeper position in the recessed portion of the diaphragm piece. As a result, the device dimension of the stem in the axial direction can be made compact.

Still further, even if the valve seat is tilted due to erection tolerance, the pressurizing position of the stem on the inner bottom surface can be positioned close to the axial center of the diaphragm piece. Thus, aligning capability can be more improved.

Still further, according to the third aspect of the embodiment, the diaphragm valve includes the retaining member for movably retaining the diaphragm piece to the axial center direction of the diaphragm piece, and the diaphragm piece has the height so as to be able to be guided by the retaining member to the axial center direction by taking the side-portion outer circumferential surface of the diaphragm piece as a sliding surface.

With this, while the height of the sliding surface for guiding the diaphragm piece and the retaining member in the axial center direction of the diaphragm piece is stably ensured, the tip portion of the stem is placed to a deeper position in the recessed portion of the diaphragm piece, thereby bringing the position where the stem pressurizes the diaphragm piece closer to the valve seat.

Thus, while the diaphragm piece is movably and stably guided in the axial center direction, the moment acting on the diaphragm piece can be suppressed small.

### BRIEF DESCRIPTION OF THE DRAWINGS

FIG. 1 is a sectional view depicting a schematic structure of a diaphragm valve according to an embodiment in a valve-open state;

FIG. 2 is a sectional view depicting a schematic structure of the diaphragm valve according to the embodiment in a valve-closed state;

FIG. 3 is a perspective sectional view of a portion near a diaphragm depicted in FIG. 1;

FIG. 4 is an enlarged view of a portion A depicted in FIG. 3;

FIG. 5 is an enlarged view of a portion B depicted in FIG. 3;

FIG. 6 is a front view of a stem;

FIG. 7 is a front sectional view of a diaphragm piece;

FIG. 8A is a diagram for describing a moment acting on the diaphragm piece when the stem in a tilted state pressurizes the diaphragm piece;

FIG. 8B is a diagram for describing a moment acting on the diaphragm piece when the stem in a tilted state pressurizes the diaphragm piece;

FIG. 9 is a diagram for describing a difference in aligning capability due to a difference in depth of an inner bottom surface of a recessed portion when the diaphragm piece is tilted in accordance with a valve seat being slightly tilted due to erection tolerance;

FIG. 10A is a diagram for describing a difference in aligning capability due to a difference in depth of the inner bottom surface of the recessed portion when the diaphragm piece is tilted in accordance with the valve seat being slightly tilted due to erection tolerance; and

FIG. 10B is a diagram for describing a difference in aligning capability due to a difference in depth of the inner bottom surface of the recessed portion when the diaphragm is tilted in accordance with the valve seat being slightly tilted due to erection tolerance.

### DETAILED DESCRIPTION OF THE INVENTION

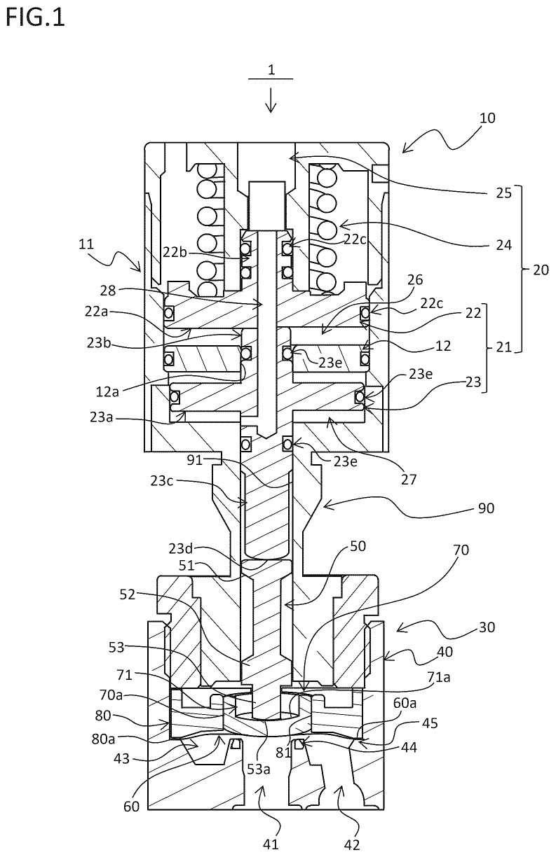

An embodiment of a diaphragm valve 1 according to the present invention is described in detail below based on FIG. 1 to FIG. 10.

Note that the present disclosure is not limited by the embodiment described below. Also, it should be noted that the drawings are schematic and a dimensional relation in each component, a ratio of each component, and/or so forth may be different from the actual one. Furthermore, among the drawings, a portion where the relation and proportions of each dimension are different may be included.

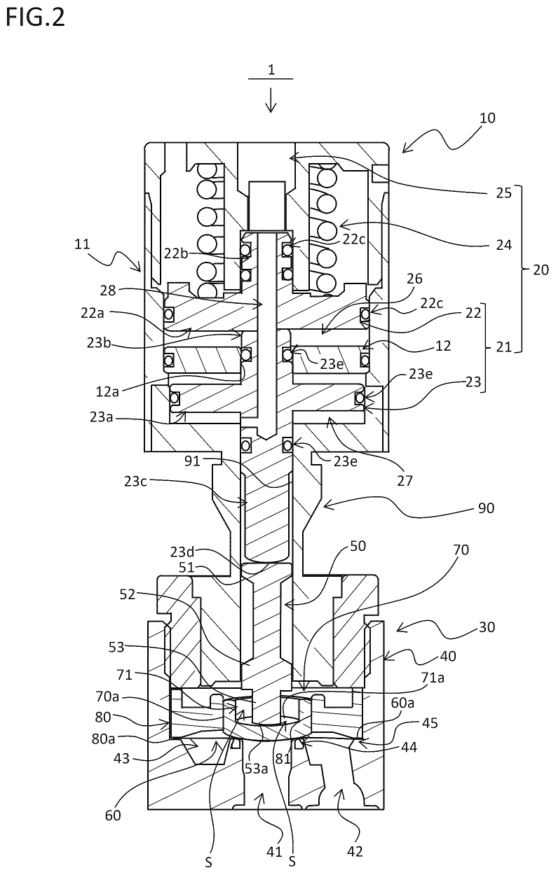

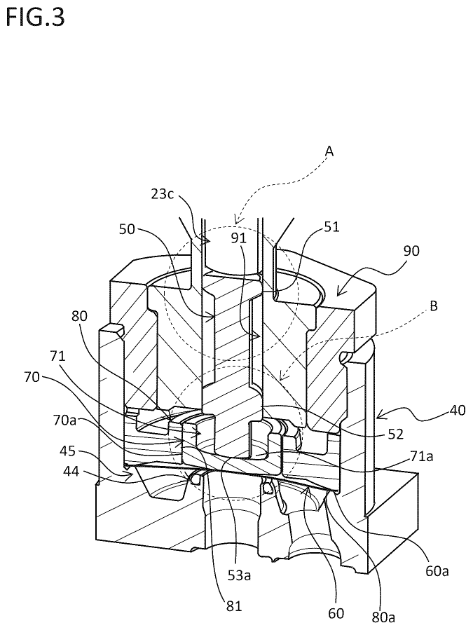

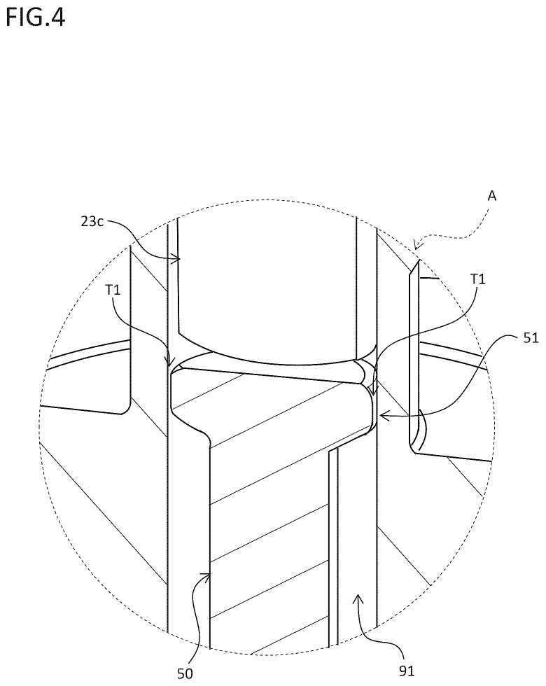

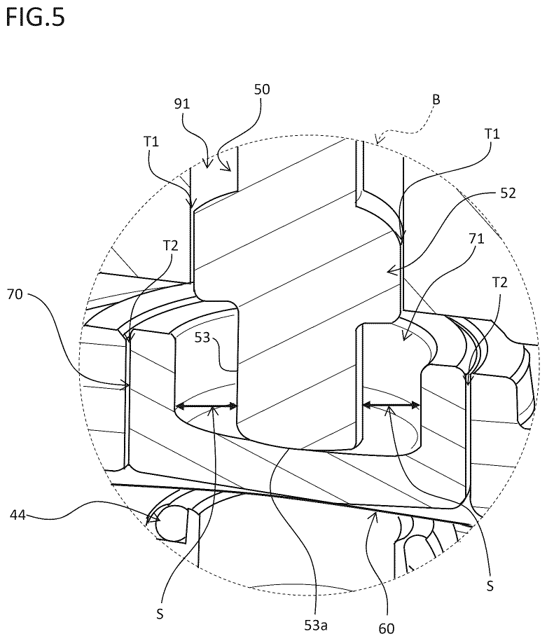

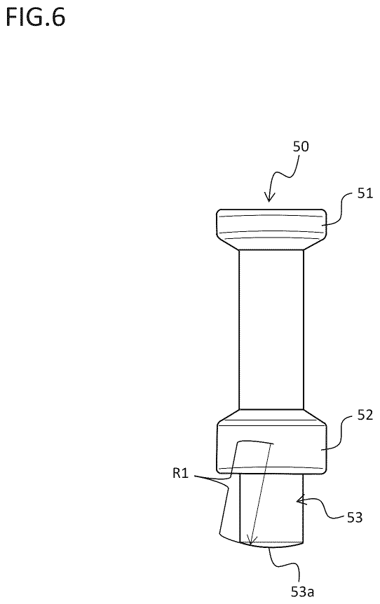

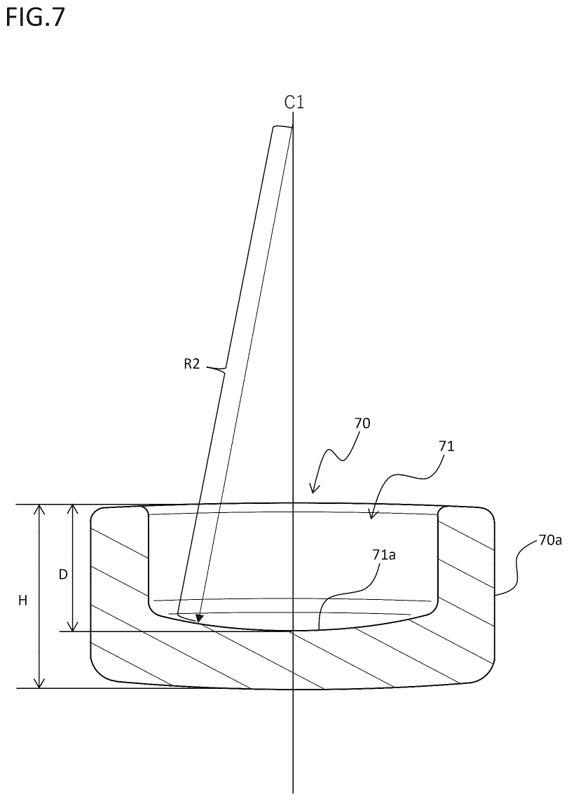

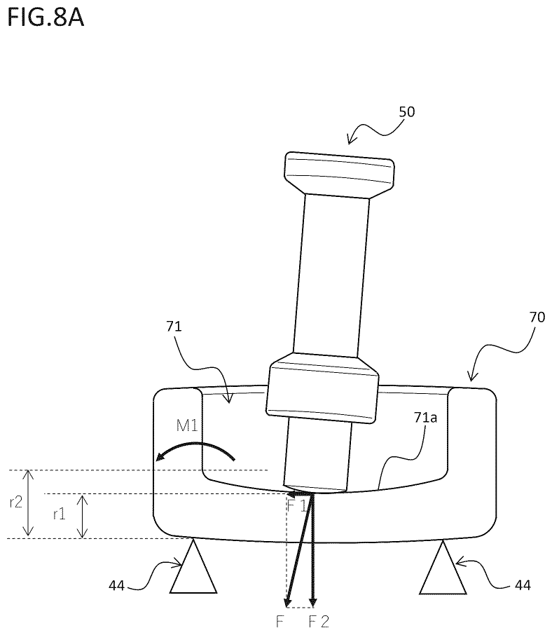

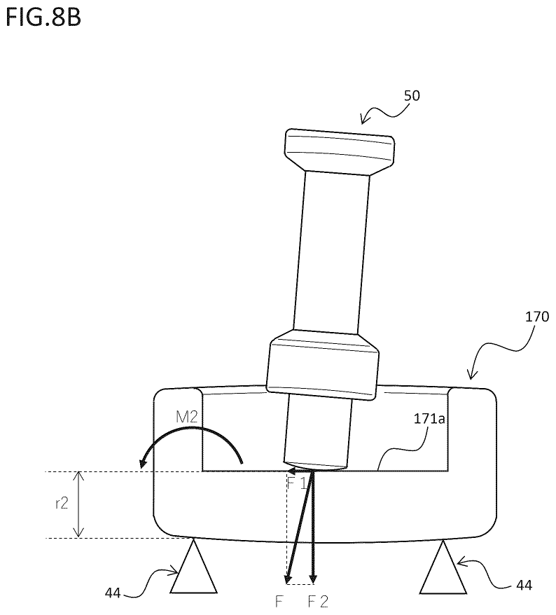

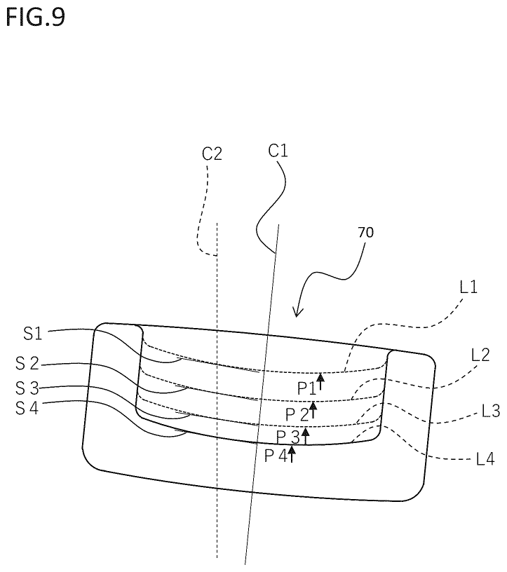

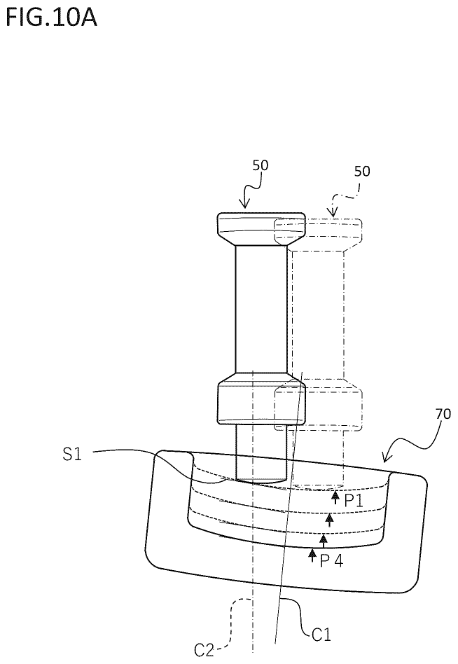

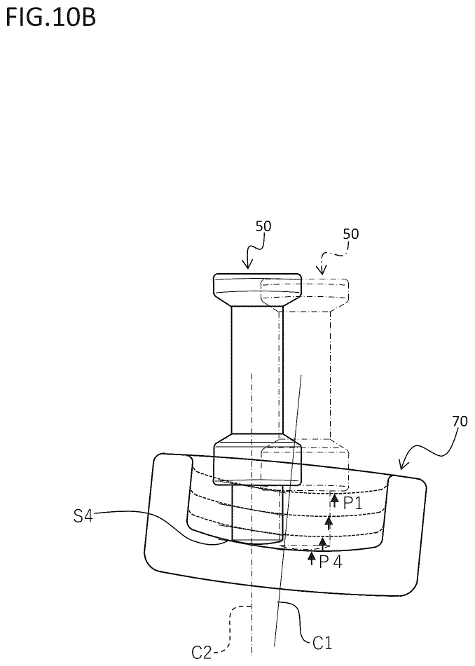

FIG. 1 is a sectional view depicting a schematic structure of the diaphragm valve 1 according to the embodiment in a valve-open state. FIG. 2 is a sectional view depicting a schematic structure of the diaphragm valve 1 according to the embodiment in a valve-closed state. FIG. 3 is a perspective sectional view of a portion near a diaphragm 60 depicted in FIG. 1. FIG. 4 is an enlarged view of a portion A depicted in FIG. 3. FIG. 5 is an enlarged view of a portion B depicted in FIG. 3. FIG. 6 is a front view of a stem 50. FIG. 7 is a front sectional view of a diaphragm piece 70. FIG. 8A and FIG. 8B are diagrams for describing a moment acting on the diaphragm piece 70 when the stem 50 in a tilted state pressurizes the diaphragm piece 70. FIG. 9, FIG. 10A, and FIG. 10B are diagrams for describing a difference in aligning capability due to a difference in depth of an inner bottom surface 71a of a recessed portion 71 when the diaphragm piece 70 is tilted in accordance with a valve seat 44 being slightly tilted due to erection tolerance.

Note that while description is made by defining an up-down direction based on the drawings for description of the structure, that direction is merely an example and is not intended to be limited.

The diaphragm valve 1 according to the embodiment of the present invention has an actuator 10, a valve body 30, and a coupling member 90 coupling the actuator 10 and the valve body 30 together.

### <On Actuator 10>

The actuator 10 functions as a drive source for the stem 50 that drives to open and close the valve. In the present embodiment, an air actuator is used as the actuator 10.

In this actuator 10, a driving mechanism 20 such as a piston 21 is accommodated in a case 11.

The driving mechanism 20 has the piston 21 that pressurizes the stem 50 to a valve-closing direction, a spring 24 that presses the piston 21 to a valve-closing direction, and an air connecting portion 25 serving as a connecting portion to an air supply source.

### <On Piston 21 of Actuator 10>

The piston 21 has a first piston 22 and a second piston 23 that section a space in the case 11 into two, air chambers 26 and 27, with a partition wall 12 interposed therebetween.

The first piston 22 has a flange portion 22a forming a flange-shaped wall partitioning the inside of the case 11 on an upper side of the partition wall 12 and a protruding shaft portion 22b protruding at the center from an upper surface side of the flange portion 22a.

The second piston 23 has a flange portion 23a forming a flange-shaped wall partitioning the inside of the case 11 on a lower side of the partition wall 12, a piston-side protruding shaft portion 23b protruding at the center from an upper surface side of the flange portion 23a, and a stem-side protruding shaft portion 23c protruding at the center from a lower surface side of the flange portion 23a.

The piston-side protruding shaft portion 23b is configured to protrude through a through hole 12a formed at the center of the partition wall 12 to the inside of the air chamber 26 on a first piston 22 side and abut on the flange portion 22a of the first piston 22.

The stem-side protruding shaft portion 23c slidably contacts the inner circumferential surface of a guide hole 91 of the coupling member 90 the diameter of which is reduced compared with the inner circumferential surface of the case 11 with which the flange portion 23a of the second piston 23 slidably makes contact, thereby causing a tip surface 23d to abut on the stem 50.

In the first piston 22 and the second piston 23 configured as described above, O rings 22c fit in the outer circumferences of the flange portion 22a and the protruding shaft portion 22b, and O rings 23e fit in the outer circumferences of the flange portion 23a, the piston-side protruding shaft portion 23b, and the stem-side protruding shaft portion 23c.

The first piston 22 and the second piston 23 can move to an axial direction as hermetically sealing a space between themselves and the inner circumferential surface of the case 11 via these O rings 22c and 23e.

In the first piston 22 and the second piston 23 configured as described above, flow paths formed in the first piston 22 and the second piston 23 are coupled to form a contiguous flow path 28 from the air connecting portion 25 to each of the air chambers 26 and 27.

The piston 21 is configured to be moved to a downward direction, which is a valve-closing direction, via the flange portion 22a of the first piston 22 pressurized by a spring-back force of the spring 24 in a state in which air supply to the air chambers 26 and 27 is stopped.

On the other hand, when air is supplied from the air supply source to the air connecting portion 25, each of the air chambers 26 and 27 is filled with air through the flow path 28 formed in the piston 21. With this, by the pressure of air filling the air chambers 26 and 27, the piston 21 is moved against the spring-back force of the spring 24 upward to a valve-open direction.

### <On Valve Body 30>

The valve body 30 has a body 40, the stem 50, the diaphragm 60 provided so as to be able to be in contact with and separated from the valve seat 44 in the body 40, the diaphragm piece 70, and a retaining member 80 retaining the diaphragm piece 70 movably in an axial center direction of the diaphragm piece 70.

### <On Body 40>

The body 40 is made of, for example, a stainless steel material, and forms an outer appearance substantially in a rectangular parallelepiped shape.

This body 40 has a primary-side flow path 41 on an upstream side into which a control fluid flows and a secondary-side flow path 42 on a downstream side out of which the control fluid flows. The valve seat 44 in an annular shape is provided on an open edge surface that lets the primary-side flow path 41 penetrate upward therethrough to be open toward a valve chamber 43.

### <On Stem 50>

The stem 50 forms an outer appearance substantially in a columnar shape, and has one end portion abutting on the stem-side protruding shaft portion 23c of the second piston 23 and the other end abutting on the diaphragm piece 70.

This stem 50 has diameter-enlarged portions 51 and 52 provided between its one end side and the other end side at two locations.

The stem 50 is configured so that the outer circumferential surfaces of the diameter-enlarged portions 51 and 52 provided as being separated in the axial direction at two upper and lower locations slidably contacts the inner circumferential surface of the guide hole 91 of the coupling member 90 to be guided in the up-down direction.

Note that the outer diameters of the diameter-enlarged portions 51 and 52 are slightly smaller than the hole diameter of the guide hole 91 so that the stem 50 is freely insertable into or extractable from the guide hole 91 in consideration of ease of disassembly and assembly, and the stem 50 has a gap T1 as a play to be arranged in the guide hole 91 (refer to FIG. 4 and FIG. 5).

Also, the stem 50 has an abutting portion 53 having an outer dimension smaller compared with the diameter-enlarged portions 51 and 52 and protruding downward further than the diameter-enlarged portion 52 on the lower side.

This abutting portion 53 is a tip portion of the stem 50 to be placed in the recessed portion 71 of the diaphragm piece 70. Note that the tip portion of the stem 50 has dimensions of the outer diameter and the length in the axial direction set at least so as to be able to be placed in the recessed portion 71 of the diaphragm piece 70.

This abutting portion 53 has a tip surface 53a in a spherical shape and abutting on the inner bottom surface 71a of the recessed portion 71 of the diaphragm piece 70.

### <On Diaphragm 60>

The diaphragm 60 forms a substantially disk shape made of a metal such as a nickel-cobalt alloy, and an outer circumferential edge portion 60a is interposed and fixed by a step portion 45 formed on the inner circumferential surface of the body 40 and a lower-end outer circumferential edge portion 80a of the retaining member 80.

In the present embodiment, when the diaphragm 60 is assembled in the body 40, after the outer circumferential edge portion 60a of the diaphragm 60 is mounted on the step portion 45 of the body 40, the lower-end outer circumferential edge portion 80a of the retaining member 80 is mounted from above the diaphragm 60 so as to be stacked on the outer circumferential edge portion 60a of the diaphragm 60. Then, with the outer circumferential edge portion 60a of the diaphragm 60 interposed between the step portion 45 and the retaining member 80, the coupling member 90 and the body 40 are screwed together, thereby making the diaphragm 60 interposed and fixed in the body 40.

The diaphragm 60 with the outer circumferential edge portion 60a fixed in this manner can be elastically deformed so that an area inside the outer circumferential edge portion 60a can be in contact with and separated from the valve seat 44.

### <On Diaphragm Piece 70>

In the diaphragm piece 70, as depicted in FIG. 3 and FIG. 7, the recessed portion 71 in a circular outer shape is formed by counterboring in one end surface of a columnar-shaped metal member.

Note that the recessed portion 71 may be formed by processing other than counterboring. The recessed portion 71 may be formed by, for example, metal molding.

The inner bottom surface 71a of this recessed portion 71 has a radius of curvature R2 larger than a radius of curvature R1 (refer to FIG. 6) of the tip surface 53a of the stem 50 and forms a spherical shape with a center portion as a lowermost surface.

Thus, the stem 50 is configured to be able to make an aligning movement along the inner bottom surface 71a while keeping the state in which the tip surface 53a abuts on the inner bottom surface 71a of the recessed portion 71.

Also, as depicted in FIG. 5, the recessed portion 71 has its dimension set so as to form a gap S that allows the abutting portion 53 of the stem 50 to make aligning movement in the recessed portion 71.

Also, the inner bottom surface 71a of this recessed portion 71 is formed at a deeper position as long as a predetermined strength can be ensured.

Note that in “a deeper position as long as a predetermined strength can be ensured” in the present embodiment, the strength is determined by a relation between a height H of the diaphragm piece 70 in an axial center direction and a depth D of the inner bottom surface 71a provided as a predetermined depth with respect to the height H and, for example, the depth D has a ratio with respect to the height H, the ratio being set so as to be as large as possible as long as durability required for the valve is satisfied.

### <On Retaining Member 80>

The retaining member 80 retains the diaphragm piece 70 movably in the axial center direction of the diaphragm piece 70.

Also, as described above, the retaining member 80 interposes and fixes the outer circumferential edge portion 60a of the diaphragm 60 from above the step portion 45 of the body 40.

This retaining member 80 forms a substantially cylindrical outer appearance, and has a guide hole 81 at a center portion as an axial center for movably retaining the diaphragm piece 70 in the axial center direction.

This diaphragm piece 70 is arranged in the guide hole 81, with a gap T2 as a slight play provided in a radial direction with respect to the guide hole 81 in consideration of ease of disassembly and assembly that allows free insertion into or extraction from the guide hole 81 and the amount of movement for alignment (refer to FIG. 5).

Here, the diaphragm piece 70 has a height H in the axial center direction that can be guided by the retaining member 80 in the axial center direction with a side-portion outer circumferential surface 70a of the diaphragm piece 70 taken as a sliding surface.

That is, the diaphragm piece 70 has the height H required for being stably guided by the retaining member 80 in the axial center direction.

Furthermore, the guide hole 81 of the retaining member 80 is set to have a dimension required for stably guiding to the axial center direction the side-portion outer circumferential surface 70a of the diaphragm piece 70 having the height H as described above.

More specifically, the guide hole 81 is set to have a height substantially equal to that of the diaphragm piece 70 in the axial center direction.

### <On Coupling Member 90>

The coupling member 90 couples the actuator 10 and the valve body 30 together. An upper end portion of the coupling member 90 is screwed into a lower end portion of the case 11 of the actuator 10 to be coupled to the case 11.

Also, a lower end portion of the coupling member 90 is screwed into an upper end portion of the valve body 30 to be coupled to the body 40.

Furthermore, a lower end surface of the coupling member 90 abuts on the upper end surface of the retaining member 80. As a fastening work by screwing of the coupling member 90 and the body 40 together proceeds, the coupling member 90 pushes the retaining member 80 downward, thereby causing the outer circumferential edge portion 60a of the diaphragm 60 to be interposed and fixed between the step portion 45 of the body 40 and the lower-end outer circumferential edge portion 80a of the retaining member 80.

### <On Moment Acting on Diaphragm Piece 70 When Stem 50 in Tilted State Pressurizes Diaphragm Piece 70>

Next, by using FIG. 8A and FIG. 8B, a moment acting on the diaphragm piece 70, 170 when the stem 50 in a tilted state pressurizes the diaphragm piece 70, 170 is described.

FIG. 8A depicts the diaphragm piece 70 with the inner bottom surface 71a being in a spherical shape, and FIG. 8B depicts the diaphragm piece 170 with an inner bottom surface 171a being in a flat shape.

In the diaphragm piece 70 depicted in FIG. 8A, the spherical inner bottom surface 71a is formed in a spherical shape by setting an outer circumferential edge equal to the depth of the flat-shaped inner bottom surface 171a of FIG. 8B and increasing the depth from the outer circumferential edge to a center portion as a lowermost bottom.

Note in FIG. 8A and FIG. 8B that, for simplification of description, the diaphragm 60 arranged between the diaphragm piece 70, 170 and the valve seat 44 is omitted and description of a force acting on the diaphragm 60 is omitted.

As depicted in FIG. 8A and FIG. 8B, when the stem 50 in a tilted state pressurizes the inner bottom surface 71a, 171a of the diaphragm piece 70, 170, a downward force F tilted with respect to a vertical direction acts on the inner bottom surface 71a, 171a.

Then, this force F acting to the tilted direction is decomposed into a force F1 in a horizontal direction and a force F2 in a vertical direction.

Thus, for example, a moment for rotating the diaphragm piece 70, 170 counterclockwise by taking a left side of the valve seat 44 in FIG. 8A and FIG. 8B as a fulcrum acts on the diaphragm piece 70, 170.

When this moment acts on the diaphragm piece 70, 170, the diaphragm piece 70, 170 moves so as to be away from a fulcrum of the valve seat 44 on a right side. Therefore, a force of the diaphragm piece 70, 170 pressurizing the valve seat 44 becomes nonuniform.

Here, when a distance in the vertical direction from the valve seat 44 as a fulcrum to a position where the stem 50 abuts on the inner bottom surface 71a, 171a is taken as r, a moment M is represented by an equation of M=F1×r.

With this, in the structure of FIG. 8A in which the inner bottom surface 71a of the diaphragm piece 70 is formed in a spherical shape, a moment M1 acting on the diaphragm piece 70 is M1=F1×r1.

Also, in the structure of FIG. 8B in which the inner bottom surface 171a of the diaphragm piece 170 is formed in a flat shape, a moment M2 acting on the diaphragm piece 170 is M2=F1×r2.

Here, from r2>r1, M2>M1.

That is, compared with the case in which the inner bottom surface 171a of the diaphragm piece 170 is formed in a flat shape, in the case in which the inner bottom surface 71a is formed in a spherical shape, the moment acting on the diaphragm piece 70, 170 can be suppressed to be small, and variability of the force pressurizing the valve seat 44 by the diaphragm piece 70, 170 can be suppressed small. As a result, it can be found that aligning capability of the diaphragm piece 70, 170 with respect to the valve seat 44 can be improved.

From this, the inventors of the present invention have found that aligning capability is improved as the moment acting on the diaphragm piece 70 is decreased and, to reduce this moment, the distance r in the vertical direction from the valve seat 44 as a fulcrum to a position where the stem 50 pressurizes the inner bottom surface 71a is decreased, that is, the depth of the inner bottom surface 71a of the diaphragm piece 70 is set deeper. The inventors have also found that the inner bottom surface 71a is formed in a spherical shape with a portion near the axial center of the inner bottom surface 71a of the diaphragm piece 70 taken as a lowermost surface to enhance aligning capability.

Furthermore, the inventors of the present invention have also found that, by forming the inner bottom surface 71a of the diaphragm piece 70 in a spherical shape, the tip of the stem 50 can be placed into a deeper position in the recessed portion 71 of the diaphragm piece 70, thereby making the device dimension of the stem 50 in the axial direction compact.

Next, by using FIG. 9, FIG. 10A, and FIG. 10B, description is made to a difference in aligning capability due to a difference in depth of the inner bottom surface 71a of the recessed portion 71 when the diaphragm piece 70 is tilted in accordance with the valve seat 44 being slightly tilted due to erection tolerance.

First, by using FIG. 9, description is made to the fact that the tilt of the inner bottom surface 71a to be pressurized by the stem 50 changes in accordance with the depth of the inner bottom surface 71a in a state in which the diaphragm piece 70 is tilted.

FIG. 9 depicts the diaphragm piece 70 tilted in response to the valve seat 44 slightly tilted due to erection tolerance.

Note that broken lines L1 to L4 depicted in the drawing indicate a plurality of inner bottom surfaces 71a changed so as to have different depths with respect to the diaphragm piece 70 having a predetermined height.

Also, a broken line C2 is indicated as a position where the stem 50 pressurizes the inner bottom surface 71a having a different depth at a point of intersection with the broken lines L1 to L4.

Furthermore, solid lines S1 to S4 each indicate a tilt of the inner bottom surface 71a at the position to be pressurized by the stem 50.

Still further, positions P1 to P4 each indicate a lowermost position of the inner bottom surface 71a having a different depth in the state of the drawing.

Still further, a solid line C1 indicates an axial center of the diaphragm piece 70.

As depicted in FIG. 9, in a state in which the diaphragm piece 70 is slightly tilted, it can be found that the tilt of the inner bottom surface 71a at the pressurizing position of the stem 50 on the inner bottom surface 71a is smaller when the inner bottom surface 71a of the diaphragm piece 70 is formed at a deeper position.

Also, it can be found that the lowermost positions P1 to P4 of the inner bottom surface 71a are closer to the axial center C1 of the diaphragm piece 70 when the inner bottom surface 71a is formed at a deeper position.

The change of the tilt of the inner bottom surface 71a at the pressurizing position of the stem 50 and the change of the lowermost position of the inner bottom surface 71a due to the difference in depth of the inner bottom surface 71a as described above bring the following difference in aligning capability.

That is, as depicted in FIG. 10A, for the diaphragm piece 70 having the inner bottom surface 71a formed at a shallow position, the tilt of the inner bottom surface 71a with which the stem 50 is in contact is large compared with the others and, furthermore, the lowermost position P1 of the inner bottom surface 71a of the diaphragm piece 70 is farther away from the axial center C1 compared with the others.

Thus, the stem 50 tends to slide on the inner bottom surface 71a toward the lowermost position P1 and tends to be moved toward the lowermost position P1 farther away from the axial center C1 of the diaphragm piece 70 along the inner bottom surface 71a. As a result, the pressurizing position of the stem 50 on the inner bottom surface 71a is moved to a position away from the axial center C1 of the diaphragm piece 70.

When the pressurizing position of the stem 50 is moved farther away from the axial center C1 of the diaphragm piece 70 in this manner, the stem 50 pressurizes the diaphragm piece 70 at a position away from the axial center C1 of the diaphragm piece 70 compared with the others.

Thus, for the diaphragm piece 70 having the inner bottom surface 71a formed at a shallow position, a load pressurizing the valve seat 44 via the diaphragm piece 70 becomes nonuniform compared with one with the inner bottom surface 71a formed at a deeper position, thereby degrading aligning capability.

On the other hand, as depicted in FIG. 10B, for the diaphragm piece 70 having the inner bottom surface 71a formed at a deeper position, the tilt of the inner bottom surface 71a with which the stem 50 is in contact is small compared with the others and, furthermore, the lowermost position P4 of the inner bottom surface 71a of the diaphragm piece 70 is closer to the axial center C1 compared with the others.

Thus, when the stem 50 is moved on the inner bottom surface 71a toward the lowermost position P4, the pressurizing position of the stem 50 on the inner bottom surface 71a tends to be moved to a position closer to the axial center C1 of the diaphragm piece 70, and the load of pressurizing the valve seat 44 via the diaphragm piece 70 can be made uniform compared with the others. Thus, aligning capability is superior compared with one having the inner bottom surface 71a formed at a shallow position.

### <On Valve-Open/Closing Operations of Diaphragm Valve 1>

Next, the valve-open/closing operations of the diaphragm valve 1 are described.

The diaphragm valve 1 in a valve-open state depicted in FIG. 1 is in a state in which the piston 21 moves to ascend against a spring-back force oriented downward by the spring 24 by a driving force of air filling each of the air chambers 26 and 27.

In this valve-open state, the diaphragm 60 is released from the pressurizing force of the stem 50 via the diaphragm piece 70 to become in an elastically neutral state, and is swelled upward to be away from the valve seat.

To this diaphragm valve 1 in the valve-open state, when air supply is stopped, with air discharged from each of the air chambers 26 and 27, the force of causing the piston 21 to ascend against the spring-back force of the spring 24 become weak, and the piston 21 is pushed downward by the spring-back force of the spring 24.

Then, with the descent of the piston 21, the stem 50 abutting on the stem-side protruding shaft portion 23c of the second piston 23 is pushed downward.

Then, with the stem 50 moving downward as being guided by the guide hole 91 of the coupling member 90, the spherical tip surface 23d pressurizes the inner bottom surface 71a of the diaphragm piece 70 to push the diaphragm piece 70 downward.

Here, the diaphragm piece 70 moves downward as being guided by the retaining member 80 to the axial center direction.

Here, since the diaphragm piece 70 is set to have a height so as to be able to be stably guided by the retaining member 80 in the axial center direction, the diaphragm piece 70 moves downward as being stably guided by the retaining member 80.

With the diaphragm piece 70 pressed downward in this manner, the diaphragm 60 is pressurized downward and deformed so that the center portion is elastically recessed, thereby being in close contact with the valve seat 44. Thus, the diaphragm valve 1 becomes in a valve-closing state depicted in FIG. 2.

Here, if the stem 50 in a tilted state pressurizes the diaphragm piece 70 at the time of pushing the diaphragm piece 70 downward, while a moment acts on the diaphragm piece 70 as described above, since the inner bottom surface 71a of the diaphragm piece 70 is formed in a spherical shape, the position where the stem 50 pressurizes the inner bottom surface 71a can be made deeper in the diaphragm piece 70, thereby suppressing a distance to the valve seat 44 in the vertical direction smaller. As a result, the moment acting on the diaphragm piece 70 can be suppressed to improve aligning capability.

Also, when the valve seat 44 is tilted due to erection tolerance or the like, the diaphragm piece 70 pressurizes the valve seat 44 as being tilted in accordance with the tilt of the valve seat 44.

In this case, as described above, by forming the inner bottom surface 71a of the diaphragm piece 70 at a deeper position, it is possible to bring the pressurizing position of the stem 50 on the inner bottom surface 71a to be positioned close to the axial center C1 of the diaphragm piece 70. Thus, aligning capability can be more improved.

### <Effects of Embodiment>

As described in the foregoing, according to the diaphragm valve 1 of the embodiment, the stem 50 has the tip surface 53a forming a spherical shape, and the diaphragm piece 70 is provided with the recessed portion 71 where the abutting portion 53, which is the tip portion of the stem 50, is placed. The recessed portion 71 has the inner bottom surface 71a having the radius of curvature R2 larger than the radius of curvature R1 of the tip surface 53a of the stem 50 and forming a spherical shape with a center portion as a lowermost surface.

With this, when the tip surface 53a of the stem 50 pressurizes the inner bottom surface 71a of the recessed portion 71 of the diaphragm piece 70 for valve closing, the stem 50 causes the spherical tip surface 53a to abut on the spherical inner bottom surface 71a of the recessed portion 71 to be moved toward the lowermost surface of the inner bottom surface 71a.

Thus, the position where the stem 50 pressurizes the diaphragm piece 70 is closer to the valve seat 44. When the stem 50 is tilted to pressurize the inner bottom surface 71a of the diaphragm piece 70 separate from the stem 50, the moment of rotating the diaphragm piece 70 is suppressed small, thereby preventing the diaphragm piece 70 from being tilted greatly to the extent that aligning capability is degraded due to a play of erection tolerance.

Therefore, in the structure with erection tolerance allowing ease of disassembly and assembly, even if a thrust force for sealing the valve seat 44 is suppressed small, aligning capability of the diaphragm piece 70 can be enhanced and seal capability of the valve seat 44 can be kept, thereby further allowing an improvement in seal capability of the valve seat 44.

Also, according to the diaphragm valve 1 of the embodiment, the inner bottom surface 71a of the recessed portion 71 of the diaphragm piece 70 is formed at a deeper position as long as a predetermined strength can be ensured. With this, the tip surface 53a of the stem 50 can pressurize the inner bottom surface 71a at a deeper position in the recessed portion 71. Since the stem 50 pressurizes the inner bottom surface 71a at a position closer to the valve seat 44, the moment acting on the diaphragm piece 70 when the stem 50 is tilted to pressurize the inner bottom surface 71a of the recessed portion 71 can be suppressed small while the strength of the diaphragm piece 70 is ensured.

Furthermore, the abutting portion 53, which is the tip portion of the stem 50, can be placed to a deeper position in the recessed portion 71 of the diaphragm piece 70. As a result, the device dimension of the stem 50 in the axial direction can be made compact.

Still further, even if the valve seat 44 is tilted due to erection tolerance, the pressurizing position of the stem 50 on the inner bottom surface 71a can be positioned close to the axial center C1 of the diaphragm piece 70. Thus, aligning capability can be more improved.

Still further, according to the diaphragm valve 1 of the embodiment, the retaining member 80 for movably retaining the diaphragm piece 70 to the axial center direction is provided, and the diaphragm piece 70 has the height H in the axial center direction so as to be able to be guided by the retaining member 80 to the axial center direction by taking the side-portion outer circumferential surface 70a of the diaphragm piece 70 as a sliding surface.

With this, while the height of the sliding surface for guiding the diaphragm piece 70 and the retaining member 80 in the axial center direction of the diaphragm piece 70 is stably ensured, the abutting portion 53, which is the tip portion of the stem 50, is placed to a deeper position in the recessed portion 71 of the diaphragm piece 70, thereby bringing the position where the stem 50 pressurizes the diaphragm piece 70 closer to the valve seat 44.

Thus, while the diaphragm piece 70 is movably and stably guided in the axial center direction, the moment acting on the diaphragm piece 70 can be suppressed small.

While the embodiment of the present discloser has been described in the foregoing, the present disclosure is not limited to the above-described embodiment but can be variously changed in a range not deviating the gist of the present invention.

For example, while the diaphragm valve is of a normal close type in the above-described embodiment, the diaphragm valve may be of a normal open type.

Also, the diaphragm valve may be of an automatic type using an actuator, but may be of a manual type using an operation handle.

The embodiment disclosed above is an example in all aspects and should not be considered as a restrictive one. In the above-described embodiment may be omitted, replaced, or changed in any of various forms without deviating from the attached scope of claims and its gist.

What is claimed is:

1. A diaphragm valve having a diaphragm piece arranged so as to freely abut on a tip of a stem and causing a valve-close state in which a diaphragm is caused to abut on a valve seat via the diaphragm piece pushed by the stem to a valve-closing direction, wherein
the stem has a tip surface forming a spherical shape,
the diaphragm piece is provided with a recessed portion where a tip portion of the stem is placed, and
the recessed portion has an inner bottom surface having a radius of curvature larger than a radius of curvature of the tip surface of the stem and forming a spherical shape with a center portion as a lowermost surface.

2. The diaphragm valve according to claim 1, wherein
the inner bottom surface of the recessed portion is formed at a deeper position as long as a predetermined strength can be ensured.

3. The diaphragm valve according to claim 1, further comprising
a retaining member for movably retaining the diaphragm piece to an axial center direction of the diaphragm piece, wherein
the diaphragm piece has a height in the axial center direction so as to be able to be guided by the retaining member to the axial center direction by taking a side-portion outer circumferential surface of the diaphragm pieces as a sliding surface.

4. The diaphragm valve according to claim 2, further comprising
a retaining member for movably retaining the diaphragm piece to an axial center direction of the diaphragm piece, wherein
the diaphragm piece has a height in the axial center direction so as to be able to be guided by the retaining member to the axial center direction by taking a side-portion outer circumferential surface of the diaphragm pieces as a sliding surface.
